(19) United States
(12) Patent Application Publication
(10) Pub. No.: US 2026/0040136 A1
(43) Pub. Date: Feb. 5, 2026

(54) METHOD AND APPARATUS FOR SUPPORTING MBS IN AN IAB NETWORK

(71) Applicant: LENOVO (BEIJING) LIMITED, Beijing (CN)

(72) Inventors: Yibin Zhuo, Shanghai (CN); Mingzeng Dai, Shanghai (CN); Lianhai Wu, Beijing (CN); Le Yan, Shanghai (CN)

(21) Appl. No.: 18/997,257

(22) PCT Filed: Jul. 22, 2022
(86) PCT No.: PCT/CN2022/107367

§ 371 Date: Jan. 21, 2025

(51) Int. Cl. H04W 28/02; H04L 47/2408; H04W 40/22; H04W 88/08

(52) U.S. Cl. CPC H04W 28/0268; H04L 47/2408; H04W 40/22; H04W 88/085

(57) ABSTRACT

Embodiments of the present disclosure relate to method and apparatus for supporting MBS in an IAB network. According to some embodiments of the disclosure, a BS may; transmit, from a CU of the BS to a network node or a DU of the BS, BH mapping information of MBS associated traffic, wherein the network node connects to the CU via the DU; and transmit MBS associated traffic to the network node or receive MBS associated traffic from the network node, via the DU and a BH link between the DU and the network node, based on the BH mapping information.

### TECHNICAL FIELD

Embodiments of the present disclosure generally relate to communication technology, and more particularly to supporting a multicast/broadcast service (MBS) in an integrated access and backhaul (IAB) network.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

To extend the coverage and availability of wireless communication systems (e.g., 5G systems), the 3rd generation partnership project (3GPP) is envisioning integrated access and backhaul (IAB) architecture for supporting multi-hop relays. In an IAB network, an IAB node may hop through one or more IAB nodes before reaching a base station (also referred to as “an IAB donor” or “a donor node”). A single hop may be considered a special instance of multiple hops. Multi-hop backhauling is beneficial because it provides a relatively greater coverage extension compared to single-hop backhauling. In a relatively high frequency radio communication system (e.g., radio signals transmitted in frequency bands over 6 GHz), relatively narrow or less signal coverage may benefit from multi-hop backhauling techniques.

The industry desires technologies for supporting an MBS in the IAB network.

### SUMMARY

Some embodiments of the present disclosure provide a base station (BS). The BS may include a centralized unit (CU); a distributed unit (DU) coupled to the CU; and a processor coupled to the CU and DU. The processor may be configured to: transmit, from the CU to a network node or the DU, backhaul (BH) mapping information of multicast/broadcast services (MBS) associated traffic, wherein the network node connects to the CU via the DU; and transmit MBS associated traffic to the network node or receive MBS associated traffic from the network node, via the DU and a BH link between the DU and the network node, based on the BH mapping information.

In some embodiments of the present disclosure, transmitting the BH mapping information may include at least one of the following: transmitting, to the network node, information for the BH link associated with a non-user plane (UP) traffic type for a MBS service; transmitting, to the network node, a mapping relation between a MBS radio bearer (MRB) or an endpoint of a F1 transport bearer of the CU and information for the BH link; transmitting, to the DU, a mapping relation between internet protocol (IP) header information of an IP packet and information for the BH link; or transmitting, to the network node or the DU, a default configuration for the BH link associated with the MBS associated traffic.

In some embodiments of the present disclosure, the processor may be further configured to transmit, from a CU-control plane (CP) to a CU-user plane (UP), a differentiated services code point (DSCP) of an internet protocol (IP) packet for downlink (DL) MBS traffic, an IPv6 flow label of the IP packet for the DL MBS traffic, or both; and wherein the CU may include the CU-CP and the CU-UP.

In some embodiments of the present disclosure, the BH link between the DU and the network node may include a BH radio link control (RLC) channel associated with quality-of-service (QOS) information of a control plane traffic type for downlink (DL) MBS control plane (CP) traffic.

In some embodiments of the present disclosure, the non-UP traffic type for a MBS service may include at least one of the following: a non-UP traffic type specific for a broadcast service or a non-UP traffic type specific for a multicast service. In some embodiments of the present disclosure, the non-UP traffic type for a MBS service is at least one of the following: user equipment (UE)-associated F1 application protocol (F1AP), non-UE-associated F1AP, or non-F1.

In some embodiments of the present disclosure, the endpoint of the F1 transport bearer of the CU may be indicated by at least one of the following: a broadcast bearer context F1-U transport network layer (TNL) info at CU information element (IE); or a MRB F1-U TNL info at CU IE for a multicast service.

In some embodiments of the present disclosure, the DSCP or the IPv6 flow label are associated with a MRB or an endpoint of a F1 transport bearer of the network node. In some embodiments of the present disclosure, the DSCP or the IPv6 flow label is associated with the IP packet transmitted through a general packet radio service tunneling protocol user plane (GTP-U) tunnel between the CU-UP and the network node of a MRB.

In some embodiments of the present disclosure, the control plane traffic type for DL MBS CP traffic may include at least one of the following: a control plane traffic type specific for a broadcast service or a control plane traffic type specific for a multicast service.

In some embodiments of the present disclosure, the default configuration may include at least one of the following: a default configuration specific for uplink (UL) MBS control plane (CP) traffic, a default configuration specific for UL MBS UP traffic, a default configuration specific for downlink (DL) MBS CP traffic, a default configuration specific for DL MBS UP traffic, a default configuration specific for UL MBS traffic, or a default configuration specific for DL MBS traffic.

In some embodiments of the present disclosure, the default configuration may include at least one of the following: a default configuration specific for a broadcast service or a default configuration specific for a multicast service.

In some embodiments of the present disclosure, the information for the BH link may include at least one of the following: a backhaul adaptation protocol (BAP) routing ID associated with the BH link, a next hop BAP address associated with the BH link, or an egress BH radio link control (RLC) channel ID associated with the BH link.

In some embodiments of the present disclosure, the IP header information of the IP packet may include at least one of the following: a destination IAB transport network layer (TNL) address of the IP packet, a destination IP address of the IP packet, a differentiated services code point (DSCP) of the IP packet, or IPv6 flow label of the IP packet.

In some embodiments of the present disclosure, the endpoint of the F1 transport bearer of the CU may include at least one of: a transport network layer (TNL) address, a transport layer address, or an IP address at the CU, or an endpoint identifier at the CU of a general packet radio service tunneling protocol (GTP) tunnel between the CU and the network node.

In some embodiments of the present disclosure, the endpoint of the F1 transport bearer of the network node may include at least one of: a transport network layer (TNL) address, a transport layer address, or an IP address at the network node, or an endpoint identifier at the network node of a general packet radio service tunneling protocol (GTP) tunnel between the CU and the network node.

Some embodiments of the present disclosure provide a network node. The network node may include: a processor; and a transceiver coupled to the processor. The transceiver may be configured to: receive, from a base station (BS), backhaul (BH) mapping information of multicast/broadcast services (MBS) associated traffic; and transmit MBS associated traffic to the BS via a BH link between the BS and the network node, based on the BH mapping information.

In some embodiments of the present disclosure, the BH mapping information may include at least one of the following: information for the BH link associated with a non-user plane (UP) traffic type for a MBS service; a mapping relation between a MBS radio bearer (MRB) or an endpoint of a F1 transport bearer of a centralized unit (CU) of the BS and information for the BH link; or a default configuration for the BH link associated with the MBS associated traffic.

In some embodiments of the present disclosure, the non-UP traffic type for a MBS service may include at least one of the following: a non-UP traffic type specific for a broadcast service or a non-UP traffic type specific for a multicast service. In some embodiments of the present disclosure, the non-UP traffic type for a MBS service is at least one of the following: user equipment (UE)-associated FI application protocol (F1AP), non-UE-associated F1AP, or non-F1.

In some embodiments of the present disclosure, the endpoint of the F1 transport bearer of the CU is indicated by at least one of the following: a broadcast bearer context F1-U transport network layer (TNL) info at CU information element (IE); or a MRB F1-U TNL info at CU IE for a multicast service.

In some embodiments of the present disclosure, the default configuration may include at least one of the following: a default configuration specific for uplink (UL) MBS control plane (CP) traffic, a default configuration specific for UL MBS UP traffic, or a default configuration specific for UL MBS traffic.

In some embodiments of the present disclosure, the default configuration may include at least one of the following: a default configuration specific for a broadcast service or a default configuration specific for a multicast service.

In some embodiments of the present disclosure, the information for the BH link may include at least one of the following: a backhaul adaptation protocol (BAP) routing ID associated with the BH link, a next hop BAP address associated with the BH link, or an egress BH radio link control (RLC) channel ID associated with the BH link.

In some embodiments of the present disclosure, the endpoint of the F1 transport bearer of the CU may include at least one of: a transport network layer (TNL) address, a transport layer address, or an IP address at the CU, or an endpoint identifier at the CU of a general packet radio service tunneling protocol (GTP) tunnel between the CU and the network node.

Some embodiments of the present disclosure provide a method performed by a base station (BS). The method may include: transmitting, from the CU to a network node or the DU, backhaul (BH) mapping information of multicast/broadcast services (MBS) associated traffic, wherein the network node connects to the CU via the DU; and transmitting MBS associated traffic to the network node or receive MBS associated traffic from the network node, via the DU and a BH link between the DU and the network node, based on the BH mapping information.

Some embodiments of the present disclosure provide a method performed by a network node. The method may include: receiving, from a base station (BS), backhaul (BH) mapping information of multicast/broadcast services (MBS) associated traffic; and transmitting MBS associated traffic to the BS or receive MBS associated traffic from BS, via a BH link between the BS and the network node, based on the BH mapping information.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an example block diagram of a protocol stack for an IAB network in accordance with some embodiments of the present disclosure;

FIG. 3 illustrates an example block diagram of a protocol stack for an IAB network in accordance with some embodiments of the present disclosure;

FIGS. 4-8 illustrate flow charts of exemplary procedures of wireless communications in accordance with some embodiments of the present disclosure; and

FIG. 9 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

Compared with the 4G communication system, the 5G communication system has raised more stringent requirements for various network performance indicators, for example, a 1000-time capacity increase, wider coverage requirements, ultra-high reliability, ultra-low latency, etc. Considering the rich frequency resources of high-frequency carriers, the use of high-frequency small station deployments is becoming more and more popular in hotspot areas in order to meet the needs of 5G ultra-high capacity. However, high-frequency carriers have poor propagation characteristics, severe attenuation due to obstructions, and limited coverage. Therefore, the dense deployment of small stations is required. In addition, the deployment of optical fiber may be difficult and costly for these small stations. Therefore, an economical and convenient backhaul scheme is needed. Integrated access and backhaul (IAB) technology, whose access link(s) and backhaul link(s) may both use wireless transmission solutions to avoid fiber deployment, provides ideas for solving the above problems.

In an IAB network, a wireless network node such as a relay node (RN) or an IAB node or a wireless backhaul node/device can provide wireless access services for UEs. For example, a UE can connect to an IAB donor relayed by one or more IAB nodes. The IAB donor may also be called a donor node or a donor base station (e.g., DgNB, Donor gNodeB). In addition, the wireless link between an IAB donor and an IAB node, or the wireless link between different IAB nodes can be referred to as a “backhaul link.” The wireless network node in an IAB network may be stationary or mobile.

An IAB node may include an IAB mobile terminal (MT) part and an IAB distributed unit (DU) part. When an IAB node connects to its parent node (which may be another IAB node or an IAB donor), it can be regarded as a UE, i.e., the role of an MT. When an IAB node provides service to its child node (which may be another IAB node or a UE), it can be regarded as a network device, i.e., the role of a DU.

An IAB donor can be an access network element with a complete base station function, or an access network element with a separate form of a centralized unit (CU) and a distributed unit (DU). The IAB donor may be connected to the core network (for example, connected to the 5G core (5GC) network), and provide the wireless backhaul function for the IAB nodes. The CU of an IAB donor may be referred to as an “IAB donor-CU” (or directly referred to as a “CU”), and the DU of the IAB donor may be referred to as an “IAB donor-DU.” The IAB donor-CU may be separated into a control plane (CP) and a user plane (UP). For example, a CU may include one CU-CP and one or more CU-UPs.

Considering the limited coverage of a high frequency band, and in order to ensure coverage performance of the network, multi-hop networking may be adopted in an IAB network. Taking into account the requirements of service transmission reliability, IAB nodes can support dual connectivity (DC) or multi-connectivity to improve the transmission reliability, so as to deal with abnormal situations that may occur on the backhaul (BH) link, such as radio link failure (RLF) or blockage, load fluctuations, etc.

In the case where an IAB network supports multi-hop and dual-connection networking, there may be multiple transmission paths between the UE and the IAB donor. A transmission path may include multiple nodes, such as a UE, one or more IAB nodes, and an IAB donor (if the IAB donor is in the form of a separate CU and DU, it may also contain an IAB donor-DU and an IAB donor-CU). Each IAB node may treat the neighboring node that provides backhaul services for it as a parent node (or parent IAB node), and each IAB node can be regarded as a child node (or child IAB node) of its parent node.

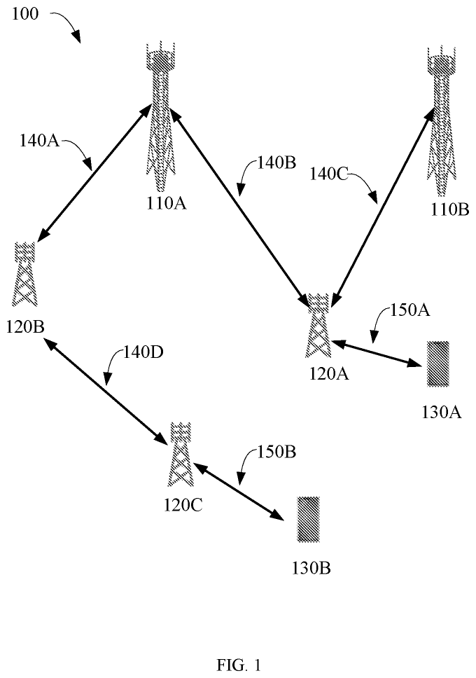

FIG. 1 illustrates a schematic diagram of wireless communication system 100 in accordance with some embodiments of the present disclosure.

As shown in FIG. 1, the wireless communication system 100 may include some base stations (e.g., IAB donor 110A and IAB donor 110B), some IAB nodes (e.g., IAB node 120A, IAB node 120B, and IAB node 120C), and some UEs (e.g., UE 130A and UE 130B). Although a specific number of UEs, IAB nodes, and IAB donors is depicted in FIG. 1, it is contemplated that any number of UEs, IAB nodes, and IAB donors may be included in the wireless communication system 100.

Each of IAB donor 110A, IAB donor 110B, IAB node 120A, IAB node 120B, and IAB node 120C may be directly connected to one or more IAB node(s) in accordance with some other embodiments of the present disclosure. Each of IAB donor 110A, IAB donor 110B, IAB node 120A, IAB node 120B, and IAB node 120C may be directly connected to one or more UEs in accordance with some other embodiments of the present disclosure.

UE 130A and UE 130B may be any type of device configured to operate and/or communicate in a wireless environment. For example, UE 130A and UE 130B may include a computing device, such as a desktop computer, a laptop computer, a personal digital assistant (PDA), a tablet computer, a smart television (e.g., television connected to the Internet), a set-top box, a game console, a security system (including a security camera), a vehicle on-board computer, a network device (e.g., router, switch, and modem), or the like. According to some embodiments of the present disclosure, UE 130A and UE 130B may include a portable wireless communication device, a smart phone, a cellular telephone, a flip phone, a device having a subscriber identity module, a personal computer, a selective call receiver, or any other device that is capable of transmission and receiving communication signals on a wireless network. In some embodiments of the present disclosure, UE 130A and UE 130B may include wearable devices, such as smart watches, fitness bands, optical head-mounted displays, internet-of-things (IOT) devices, or the like. Moreover, UE 130A and UE 130B may be referred to as a subscriber unit, a mobile, a mobile station, a user, a terminal, a mobile terminal, a wireless terminal, a fixed terminal, a subscriber station, a user terminal, or a device, or described using other terminology used in the art.

IAB donors 110A and 110B may be in communication with a core network (not shown in FIG. 1). The core network (CN) may include a plurality of core network components, such as a mobility management entity (MME) (not shown in FIG. 1) or an access and mobility management function (AMF) (not shown in FIG. 1). The CNs may serve as gateways for the UEs to access a public switched telephone network (PSTN) and/or other networks (not shown in FIG. 1).

Wireless communication system 100 may be compatible with any type of network that is capable of transmitting and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, IAB donors 110A and 110B may transmit data using an orthogonal frequency division multiple (OFDM) modulation scheme on the DL. UE 130A and UE 130B may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

Persons skilled in the art should understand that as technology develops and advances, the terminologies described in the present disclosure may change, but should not affect or limit the principles and spirit of the present disclosure.

Referring to FIG. 1, IAB node 120A can be directly connected to IAB donors 110A and 110B, and IAB node 120B can be directly connected to IAB donor 110A. IAB donors 110A and 110B are parent nodes of IAB node 120A, and IAB donor 110A is a parent node of IAB node 120B. In other words, IAB nodes 120A and 120B are child IAB nodes of IAB donor 110A, and IAB node 120A is also a child IAB node of IAB donor 110B. IAB node 120C can reach IAB donor 110A by hopping through IAB node 120B. IAB node 120B is a parent IAB node of IAB node 120C. In other words, IAB node 120C is a child IAB node of IAB node 120B.

In some other embodiments of the present disclosure, an IAB node may be connected to IAB node 120C so it can reach IAB donor 110A by hopping through IAB node 120C and IAB node 120B. This IAB node and IAB node 120C may be referred to as the descendant IAB nodes of IAB node 120B.

UEs 130A and 130B can be connected to IAB nodes 120A and 120C, respectively. IAB nodes 120A and 120C may therefore be referred to as an access IAB node. Uplink (UL) packets (e.g., data or signaling) from UE 130A or UE 130B can be transmitted to an IAB donor (e.g., IAB donor 110A or 110B) via one or more IAB nodes, and then transmitted by the IAB donor to a mobile gateway device (such as the user plane function (UPF) in the 5GC). Downlink (DL) packets (e.g., data or signaling) can be transmitted from the IAB donor (e.g., IAB donor 110A or 110B) after being received by the gateway device, and then transmitted to UE 130A or 130B through one or more IAB nodes.

For example, referring to FIG. 1, UE 130A may transmit UL data to IAB donor 110A or 110B or receive DL data therefrom via IAB node 120A. UE 130B may transmit UL data to IAB donor 110A or receive DL data therefrom via IAB node 120C and IAB node 120B.

In an IAB deployment such as the wireless communication system 100, the radio link between an IAB donor (e.g., IAB donor 110A or 110B in FIG. 1) and an IAB node or between two IAB nodes may be referred to as a backhaul link (BL). The radio link between an IAB donor (e.g., IAB donor 110A or 110B in FIG. 1) and a UE or between an IAB node and a UE may be referred to as an access link (AL). For example, in FIG. 1, radio links 140A to 140D are BLs and radio links 150A and 150B are ALs.

A protocol layer, the backhaul adaptation protocol (BAP) layer, located above the radio link control (RLC) layer, is introduced in an IAB system and can be used to realize packet routing, bearer mapping and flow control on the wireless backhaul link.

An F1 interface may be established between an IAB node (e.g., DU part of the IAB node) and an IAB donor (e.g., IAB donor-CU). The F1 interface may support both a user plane protocol (e.g., F1-U) and a control plane protocol (e.g., F1-C). The user plane protocol of the F1 interface may include one or more of a general packet radio service (GPRS) tunneling protocol user plane (GTP-U), user datagram protocol (UDP), internet protocol (IP) and other protocols. The control plane protocol of the F1 interface may include one or more of an F1 application protocol (F1AP), stream control transport protocol (SCTP), IP, and other protocols.

Through the control plane of the F1 interface, an IAB node and an IAB donor can perform, for example, interface management, IAB-DU management, and a UE context-related configuration. Through the user plane of the F1 interface, an IAB node and an IAB donor can perform, for example, user plane data transmission and downlink transmission status feedback functions.

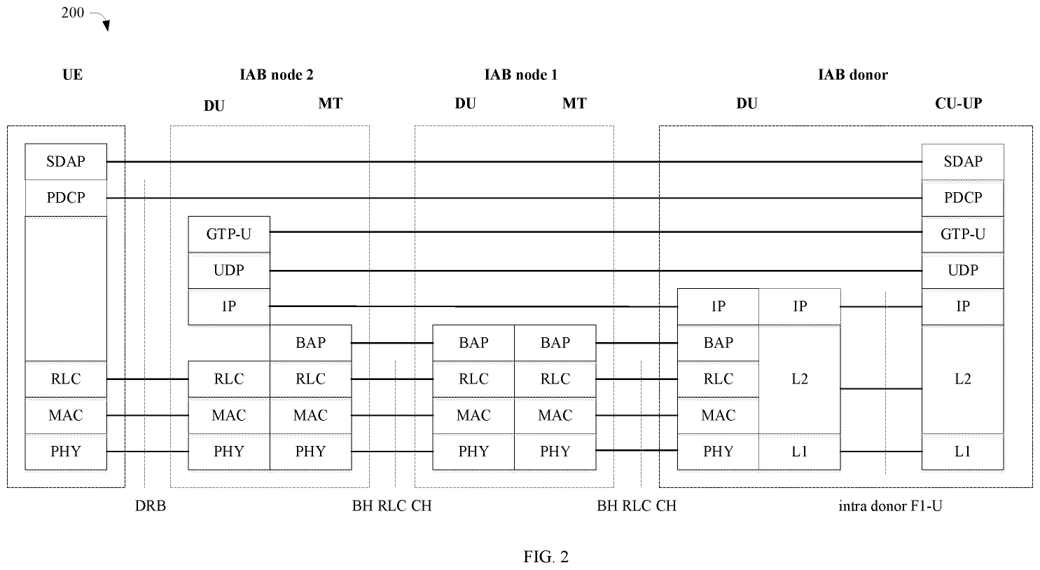

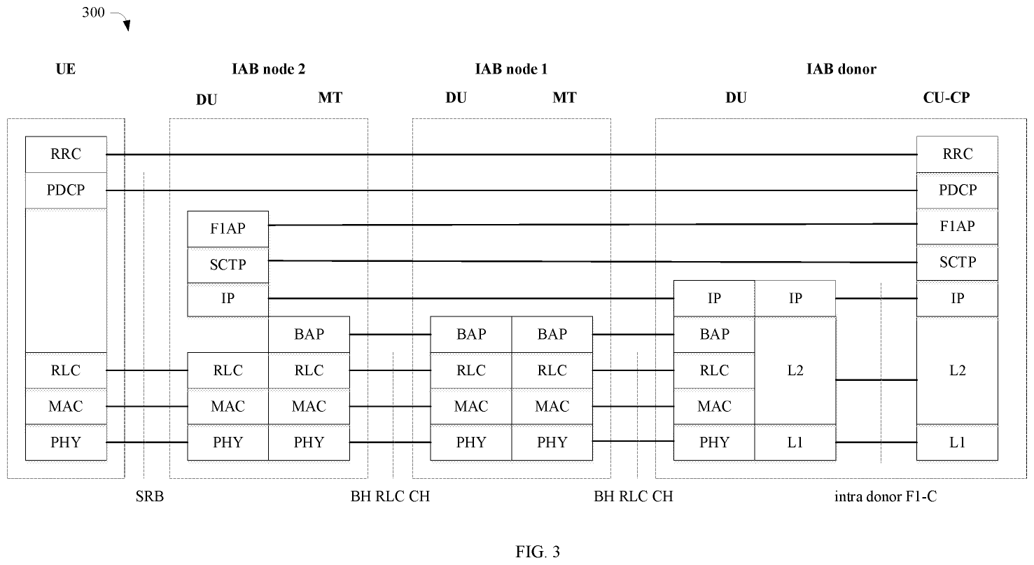

FIG. 2 illustrates an example block diagram of user plane (UP) protocol stack 200 for an IAB network according to some embodiments of the present disclosure. FIG. 3 illustrates an example block diagram of control plane (CP) protocol stack 300 for an IAB network according to some embodiments of the present disclosure. In FIGS. 2 and 3, a UE may be connected to an IAB donor via IAB node 2 and IAB node 1. In some other embodiments of the present disclosure, a UE may be connected to an IAB donor via more or less IAB nodes.

Referring to FIG. 2, the UP protocol stack of the UE may include a service data adaptation protocol (SDAP) layer, a packet data convergence protocol (PDCP) layer, a radio link control (RLC) layer, a medium access control (MAC) layer, and a physical (PHY) layer. The UP protocol stack of the DU of IAB node 2 may include a GTP-U layer, a UDP layer, an IP layer, an RLC layer, a MAC layer, and a PHY layer. The UP protocol stack of the MT of IAB node 2 or the DU or MT of IAB node 1 may include a BAP layer, an RLC layer, a MAC layer, and a PHY layer. The UP protocol stack of the DU of the IAB donor may include an IP layer, a BAP layer, an RLC layer, a MAC layer, and a PHY layer, where the PHY layer belongs to layer 1 (L1), and the BAP layer, the RLC layer, and the MAC layer belong to layer 2 (L2). The protocol stack of the CU-UP of the IAB donor may include a GTP-U layer, a UDP layer, an IP layer, an SDAP layer, a PDCP layer, an L2 layer(s), and an L1 layer.

Referring to FIG. 3, the CP protocol stack of the UE may include a radio resource control (RRC) layer, a PDCP layer, an RLC layer, a MAC layer, and a physical (PHY) layer. The CP protocol stack of the DU of IAB node 2 may include an F1AP layer, an SCTP layer, an IP layer, an RLC layer, a MAC layer, and a PHY layer. The CP protocol stack of the MT of IAB node 2 or the DU or MT of IAB node 1 may include a BAP layer, an RLC layer, a MAC layer, and a PHY layer. The CP protocol stack of the DU of the IAB donor may include an IP layer, a BAP layer, an RLC layer, a MAC layer, and a PHY layer, where the PHY layer belongs to L1, and the BAP layer, the RLC layer, and the MAC layer belong to L2. The protocol stack of the CU-CP of the IAB donor may include an RRC layer, a PDCP layer, an F1AP layer, an SCTP layer, an IP layer, an L2 layer(s), and an L1 layer.

The protocol stacks shown in FIGS. 2 and 3 are only for illustrative purposes. For example, the sequences of some of the protocol layers in the protocol stacks of FIGS. 2 and 3 may be rearranged for illustrative purposes. For example, although the SDAP and PDCP layers belong to L2, they are shown above the GTP-U layer, the UDP layer and the IP layer in the protocol stack of the CU-UP of the IAB donor in FIG. 2.

The signals between each node in an IAB network may include, for example, the following and can be applied to the present disclosure:
an IAB donor-CU and an IAB donor-DU: an F1AP message;
an IAB donor-CU and an IAB node: an F1AP message between the CU and the IAB-DU or an RRC message between the CU and the IAB-MT;
an IAB donor-CU and a UE: an RRC message;
an access IAB node and a UE: L2 control PDU such as a MAC control element (CE) or a RLC control PDU; and
an IAB node and another child or parent IAB node: L2 control PDU such as a MAC CE, a RLC control PDU, or a BAP control PDU.

Regarding BAP routing in an IAB network, each UL or DL packet in a BH link may be mapped to a specific BAP routing identity (ID) and added in the BAP header. The BAP routing ID may be configured by an IAB donor-CU. The BAP routing ID may include a BAP address which indicates the BAP address of a destination node in the BH link. The destination node of the BH link for DL and UL are an access IAB node and an IAB donor-DU, respectively. In addition, the BAP routing ID may further include a path ID which indicates the routing path terminated at the destination node.

In some embodiments of the present disclosure, a communication system (e.g., an NR system) may enable efficient resource delivery of multicast/broadcast services (MBS).

For example, for a broadcast communication service, the same service and the same specific content data may be provided simultaneously to all UEs in a geographical area. For example, all UEs in the broadcast service area may be authorized to receive data. A broadcast communication service may be delivered to the UEs using a broadcast session. A UE can receive a broadcast communication service in an RRC_IDLE state, an RRC_INACTIVE state or an RRC_CONNECTED state.

For example, for a multicast communication service, the same service and the same specific content data are provided simultaneously to a dedicated set of UEs. For example, not all UEs in the multicast service area are authorized to receive the data. For example, UEs in an MBS group may be authorized to receive data associated with the corresponding MBS. A multicast communication service may be delivered to the UEs using a multicast session. A UE can receive a multicast communication service in an RRC_CONNECTED state with mechanisms such as point-to-point (PTP) delivery or point-to-multipoint (PTM) delivery. Hybrid automatic repeat request (HARQ) feedback and retransmission can be applied to both PTP and PTM transmissions.

Since the overall next generation-radio access network (NG-RAN) architecture specified applies for the MBS, it is reasonable for the IAB architecture to apply for the MBS as well. Embodiments of the present disclosure provide solutions for supporting the MBS in an IAB network. For example, solutions for delivering MBS-associated traffic over a BH link (e.g., a multi-hop BH link) in the IAB architecture are proposed. More details on the embodiments of the present disclosure will be illustrated in the following text in combination with the appended drawings.

It should be noted that, although embodiments of the present disclosure are discussed under a specific network architecture (e.g., the IAB architecture), embodiments of the present disclosure are also applicable to other similar network architectures and new service scenarios.

In some embodiments of the present disclosure, the following quality-of-service (QOS) model may apply to both multicast and broadcast services:
an MBS session resource may be associated with one or more MBS QoS flows; and
each MBS QoS flow may be associated with a QoS profile.

In some embodiments of the present disclosure, an SDAP layer (also referred to as SDAP sublayer) may provide a mapping between an MBS QoS flow and an MBS radio bearer (MRB).

In some embodiments of the present disclosure, there may be the following MBS-associated traffic over the F1 interface:
MBS F1-C traffic (e.g., MBS-associated services in F1AP):
   This may be related to an MBS service. An F1AP function that provides the MBS service may be associated with an MBS-associated signaling connection that is maintained for the MBS service in question.
MBS F1-U traffic:
   DL: multicast/broadcast UP traffic; and
   UL: information related to flow control for DL MBS traffic, such as downlink data deliver status (DDDS) information.

It should be noted that the above traffic types are only for illustrative purposes. The MBS-associated traffic may include any other types. Embodiments of the present disclosure are also applicable to these types that are mentioned in the above examples.

In some embodiments of the present disclosure, to support MBS CP traffic and MBS UP traffic in the UL over a BH link (e.g., a multi-hop BH link), certain configurations may be required. As described above, an example of UL MBS CP traffic includes MBS-associated signaling defined in F1AP. The MBS-associated signaling may be transmitted from a DU of a BS or from a DU of an IAB node to a CU of the BS. For example, the MBS-associated signaling may include “BROADCAST CONTEXT SETUP RESPONSE” and “MULTICAST CONTEXT SETUP RESPONSE” as specified in 3GPP specifications, or any other signaling. An example of UL MBS UP traffic includes DDDS from a DU of a BS or from a DU of an IAB node to a CU of the BS.

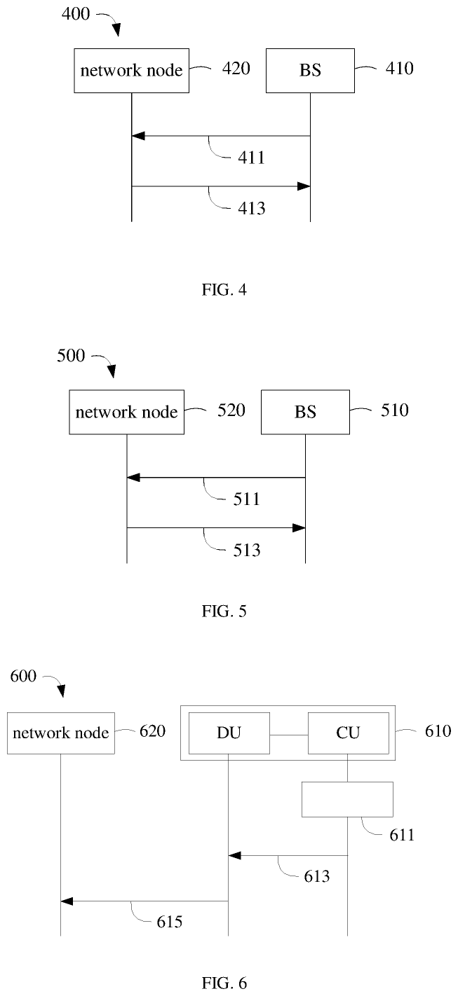

FIG. 4 illustrates a flow chart of exemplary procedure 400 for wireless communications in accordance with some embodiments of the present disclosure. Details described in all of the foregoing embodiments of the present disclosure are applicable for the embodiments shown in FIG. 4. For example, BS 410 may function as the IAB donors as described above, and network node 420 may function as the IAB nodes as described above.

Referring to FIG. 4, network node 420 may communicate with BS 410. In some examples, network node 420 may directly connect to BS 410 (e.g., without any other network node connected between network node 420). In some examples, network node 420 may indirectly connect to BS 410 (e.g., one or more other network nodes may be connected between network node 420 and BS 410).

In some embodiments, BS 410 may include a CU and a DU, which may be co-located or located separately. Network node 420 may connect to the CU of BS 410 via the DU of BS 410. Network node 420 can communicate with the DU of BS 410 via a BH link between the DU of BS 410 and network node 420. The BH link may be a multi-hop BH link.

In operation 411, BS 410 (e.g., CU of BS 410) may transmit, to network node 420, BH mapping information of MBS associated traffic. In some embodiments, the MBS associated traffic may include UL MBS CP traffic, and the BH mapping information may include BH mapping information of the UL MBS CP traffic.

In some embodiments, the BH mapping information may include information for the BH link associated with a non-UP traffic type for an MBS service. In some embodiments, the information for the BH link between the DU of BS 410 and network node 420 may include at least one of the following: a BAP routing ID associated with the BH link, a next hop BAP address associated with the BH link, or an egress BH RLC channel (CH) ID associated with the BH link.

For example, in some embodiments, a new type of non-UP traffic may be introduced as the non-UP traffic type for MBS service associated signaling. In some embodiments, the non-UP traffic type for an MBS service may be applied to both broadcast and multicast services. In some embodiments, the non-UP traffic type for an MBS service may include at least one of the following: a non-UP traffic type specific for a broadcast service or a non-UP traffic type specific for a multicast service.

For example, in some embodiments, the non-UP traffic type for an MBS service may reuse a certain non-UP traffic type(s). For example, the non-UP traffic type for an MBS service may reuse at least one of the following: UE-associated F1AP, non-UE-associated F1AP, or non-F1.

In the above embodiments, the BH mapping information can be configured via an F1AP message. For example, the F1AP message may be “F1 SETUP RESPONSE”, “GNB-DU CONFIGURATION UPDATE ACKNOWLEDGE”, or “GNB-CU CONFIGURATION UPDATE” as specified in 3GPP specifications, or any other F1AP message.

In some embodiments, the BH mapping information may include a default configuration for the BH link associated with the MBS associated traffic. In some embodiments, the BH mapping information may include a default configuration specific for UL MBS traffic (e.g., for UL MBS CP traffic, UL MBS UP traffic, or both). In some embodiments, the BH mapping information may include a default configuration specific for UL MBS CP traffic.

In some embodiments, the default configuration can be separately configured for broadcast and multicast. For example, the default configuration may include at least one of the following: a default configuration specific for a broadcast service or a default configuration specific for a multicast service. For example, the default configuration for the BH link associated with the MBS associated traffic may include at least one of: a default configuration associated with the broadcast associated traffic or a default configuration associated with the multicast associated traffic. For example, the default configuration specific for UL MBS traffic may include at least one of: a default configuration specific for UL broadcast traffic or a default configuration specific for UL multicast traffic. For example, the default configuration specific for UL MBS CP traffic may include at least one of: a default configuration specific for UL broadcast CP traffic or a default configuration specific for UL multicast CP traffic.

In some embodiments, the default configuration may include at least one of the following: a default BH RLC CH (e.g., for UL) or a default BAP routing ID (e.g., for UL).

In the above embodiments, the default configuration can be configured via an RRC message.

In operation 413, network node 420 may transmit MBS associated traffic (e.g., UL MBS CP traffic) to BS 410 based on the received BH mapping information via the DU of BS 410 and the BH link between the DU of BS 410 and network node 420.

For example, the BAP layer of network node 420 may transmit, to BS 410, a UL packet of MBS CP traffic based on the BH mapping information, in response to receiving the UL packet from, for example, an upper layer. For example, the BAP layer of network node 420 may add the BAP routing ID in the BH mapping information (e.g., in the information for the BH link) or a default UL BAP routing ID (e.g., in the default configuration) to the BAP header of the UL packet, and map the UL packet to the egress BH RLC CH in the BH mapping information (e.g., in the information for the BH link) or a default UL BH RLC CH (e.g., in the default configuration).

It should be appreciated by persons skilled in the art that the sequence of the operations in exemplary procedure 400 may be changed and some of the operations in exemplary procedure 400 may be eliminated or modified, without departing from the spirit and scope of the disclosure.

FIG. 5 illustrates a flow chart of exemplary procedure 500 for wireless communications in accordance with some embodiments of the present disclosure. Details described in all of the foregoing embodiments of the present disclosure are applicable for the embodiments shown in FIG. 5. For example, BS 510 may function as the IAB donors as described above, and network node 520 may function as the IAB nodes as described above.

Referring to FIG. 5, network node 520 may communicate with BS 510. In some examples, network node 520 may directly connect to BS 510 (e.g., without any other network node connected between network node 520). In some examples, network node 520 may indirectly connect to BS 510 (e.g., one or more other network nodes may be connected between network node 520 and BS 510).

In some embodiments, BS 510 may include a CU and a DU, which may be co-located or located separately. Network node 520 may connect to the CU of BS 510 via the DU of BS 510. Network node 520 can communicate with the DU of BS 510 via a BH link between the DU of BS 510 and network node 520. The BH link may be a multi-hop BH link.

In operation 511, BS 510 (e.g., CU of BS 510) may transmit, to network node 520, BH mapping information of MBS associated traffic. In some embodiments, the MBS associated traffic may include UL MBS UP traffic, and the BH mapping information may include BH mapping information of the UL MBS UP traffic.

In some embodiments, the BH mapping information may include a mapping relation between a MRB (e.g., a MRB ID) or an endpoint of an F1 transport bearer of the CU of BS 510 and information for the BH link between the DU of BS 510 and network node 520. In some embodiments, the information for the BH link between the DU of BS 510 and network node 520 may include at least one of the following: a BAP routing ID associated with the BH link, a next hop BAP address associated with the BH link, or an egress BH RLC CH ID associated with the BH link.

In some embodiments, the endpoint of the F1 transport bearer of the CU of BS 510 may be indicated by a broadcast bearer context F1-U transport network layer (TNL) info at CU information element (IE). The IE may be included in an F1AP message “BROADCAST CONTEXT SETUP REQUEST” or “BROADCAST CONTEXT MODIFICATION REQUEST” as specified in 3GPP specifications, or any other F1AP message.

In some embodiments, the endpoint of the F1 transport bearer of the CU of BS 510 may be indicated by a MRB F1-U TNL info at CU IE for a multicast service. The IE may be included in an F1AP message “MULTICAST DISTRIBUTION SETUP RESPONSE”, “MULTICAST CONTEXT SETUP REQUEST”, or “MULTICAST CONTEXT MODIFICATION REQUEST” as specified in 3GPP specifications, or any other F1AP message.

In some embodiments, the endpoint of the F1 transport bearer of the CU of BS 510 may include at least one of: a TNL address, a transport layer address or an IP address at the CU of BS 510, or an endpoint identifier at the CU of a GTP tunnel (also referred to as GTP tunnel endpoint identifier) between the CU of BS 510 and network node 520. In some examples, transport layer address is an IP address to be used for the F1 UP transport. In some examples, the GTP tunnel endpoint identifier is to be used for the UP transport between the CU of BS 510 and the DU of BS 510. In some examples, the endpoint of the F1 transport bearer of the CU may be also referred as UL UP TNL Information.

In some embodiments, the BH mapping information may include a default configuration for the BH link associated with the MBS associated traffic. In some embodiments, the BH mapping information may include a default configuration specific for UL MBS traffic (e.g., for UL MBS CP traffic, UL MBS UP traffic or both). In some embodiments, the BH mapping information may include a default configuration specific for UL MBS UP traffic.

In some embodiments, the default configuration can be separately configured for broadcast and multicast. For example, the default configuration may include at least one of the following: a default configuration specific for a broadcast service or a default configuration specific for a multicast service. For example, the default configuration for the BH link associated with the MBS associated traffic may include at least one of: a default configuration associated with the broadcast associated traffic or a default configuration associated with the multicast associated traffic. For example, the default configuration specific for UL MBS traffic may include at least one of a default configuration specific for UL broadcast traffic or a default configuration specific for UL multicast traffic. For example, the default configuration specific for UL MBS UP traffic may include at least one of a default configuration specific for UL broadcast UP traffic or a default configuration specific for UL multicast UP traffic.

In some embodiments, the default configuration may include at least one of the following: a default BH RLC CH (e.g., for UL) or a default BAP routing ID (e.g., for UL).

In the above embodiments, the default configuration can be configured via an RRC message.

In operation 513, network node 520 may transmit MBS associated traffic (e.g., UL MBS UP traffic) to BS 510 based on the received BH mapping information via the DU of BS 510 and the BH link between the DU of BS 510 and network node 520.

For example, the BAP layer of network node 520 may transmit, to BS 510, a UL packet of MBS UP traffic based on the BH mapping information, in response to receiving the UL packet from, for example, an upper layer.

For example, based on the MRB ID of the UL packet, or based on the UL UP TNL Information (e.g., the endpoint of the F1 transport of the CU of the BS) of the UL packet, the BAP layer of network node 520 may add the BAP routing ID in the corresponding information for the BH link as configured by the BH mapping information, and map the UL packet to the egress BH RLC CH in the corresponding information for the BH link as configured by the BH mapping information.

For example, based on the default configuration, the BAP layer of network node 520 may add a default UL BAP routing ID to the BAP header of the UL packet, and map the UL packet to a default UL BH RLC CH.

It should be appreciated by persons skilled in the art that the sequence of the operations in exemplary procedure 500 may be changed and some of the operations in exemplary procedure 500 may be eliminated or modified, without departing from the spirit and scope of the disclosure.

In some embodiments of the present disclosure, to support MBS CP traffic and MBS UP traffic in the DL over a BH link (e.g., a multi-hop BH link), certain configurations may be required. As described above, an example of DL MBS CP traffic includes MBS-associated signaling defined in F1AP. The MBS-associated signaling may be transmitted which from a CU of a BS to a DU of the BS or to a DU of an IAB node. For example, the MBS-associated signaling may include “BROADCAST CONTEXT SETUP REQUEST” and “MULTICAST CONTEXT SETUP REQUEST” as specified in 3GPP specifications, or any other signaling. An example of DL MBS UP traffic includes DL multicast/broadcast traffic such as television broadcasting.

FIG. 6 illustrates a flow chart of exemplary procedure 600 for wireless communications in accordance with some embodiments of the present disclosure. Details described in all of the foregoing embodiments of the present disclosure are applicable for the embodiments shown in FIG. 6. For example, BS 610 may function as the IAB donors as described above, and network node 620 may function as the IAB nodes as described above.

Referring to FIG. 6, network node 620 may communicate with BS 610. In some examples, network node 620 may directly connect to BS 610 (e.g., without any other network node connected between network node 620). In some examples, network node 620 may indirectly connect to BS 610 (e.g., one or more other network nodes may be connected between network node 620 and BS 610).

In some embodiments, BS 610 may include a CU and a DU, which may be co-located or located separately. The CU and DU of BS 610 may transmit data or signaling to each other. The CU of BS 610 may include a CU-CP and a CU-UP. Network node 620 may connect to the CU of BS 610 via the DU of BS 610. Network node 620 can communicate with the DU of BS 610 via a BH link between the DU of BS 610 and network node 620. The BH link may be a multi-hop BH link.

In some embodiments, information related to an IP packet(s) for the DL MBS UP traffic may need to be transmitted to the CU-UP of BS 610 such that the DL MBS UP traffic can be delivered more properly. For example, in operation 611, the CU-CP of BS 610 may transmit, to the CU-UP of BS 610, a differentiated services code point (DSCP) of an IP packet for DL MBS traffic, an IPv6 flow label of the IP packet for the DL MBS traffic, or both. The information may be transmitted for both broadcast and multicast. Based on the received information from the CU-CP above, the CU-UP can set the value of DSCP or IPv6 flow label properly in IP headers of the IP packets for the DL MBS UP traffic.

In some embodiments, the DSCP or the IPv6 flow label of an IP packet for the DL MBS traffic may be associated with a MRB (c.g., MRB ID) or an endpoint of an F1 transport bearer of network node 620 (e.g., DU of network node 620). For example, the endpoint of an F1 transport bearer of network node 620 (c.g., DU of network node 620) may be indicated by an MBS F1-U information at DU IE. The IE may include a DL IP address and TEID associated with network node 620 (c.g., DU of network node 620). For example, the endpoint of an F1 transport bearer of network node 620 (e.g., DU of network node 620) may include at least one of: a TNL address, a transport layer address or an IP address at network node 620 (c.g., DU of network node 620), or an endpoint identifier at network node 620 (c.g., DU of network node 620) of a GTP tunnel between the CU of BS 610 and network node 620 (c.g., DU of network node 620). In some examples, the endpoint of the F1 transport bearer of the network node may be also referred as DL UP TNL Information.

In some embodiments, the DSCP or the IPv6 flow label of an IP packet for the DL MBS traffic may be associated with an IP packet transmitted through a GTP-U tunnel between the CU-UP of BS 610 and network node 620 of a MRB

The above information may be transmitted via an E1 application protocol (E1AP) message in operation 611. For example, for broadcast, the E1AP message may be “BC BEARER CONTEXT SETUP REQUEST”, or “BC BEARER CONTEXT MODIFICATION REQUEST”, or “BC BEARER CONTEXT MODIFICATION CONFIRM” as specified in 3GPP specifications, or any other E1AP message. For example, for multicast, the E1AP may be “MC BEARER CONTEXT SETUP REQUEST”, “MC BEARER CONTEXT MODIFICATION REQUEST”, or “MC BEARER CONTEXT MODIFICATION CONFIRM” as specified in 3GPP specifications, or any other E1AP message.

In some embodiments, BS 610 (e.g., CU of BS 610) may transmit, to DU of BS 610, BH mapping information of MBS associated traffic. In some embodiments, the MBS associated traffic may include DL MBS traffic (e.g., DL MBS CP traffic and DL MBS UP traffic). For example, in operation 613, CU of BS 610 may transmit, to DU of BS 610, the BH mapping information including BH mapping information of DL MBS traffic.

In some embodiments, the BH mapping information may include a mapping relation between IP header information of an IP packet and information for the BH link between the DU of BS 610 and network node 620. In some embodiments, the IP header information of the IP packet may include at least one of the following: a destination IAB TNL or IP address of the IP packet, a DSCP of the IP packet, or an IPv6 flow label of the IP packet. In some embodiments, the information for the BH link between the DU of BS 610 and network node 620 may include at least one of the following: a BAP routing ID associated with the BH link, a next hop BAP address associated with the BH link, or an egress BH RLC CH ID associated with the BH link.

In the above embodiments, the above BH mapping information can be configured via an F1AP message, and can be applied for both DL MBS CP and UP traffic.

In some embodiments, for a BH RLC CH in the BH link between the DU of BS 610 and network node 620 used for MBS associated traffic, a control plane traffic type may be associated with the QoS information of the BH RLC CH for DL MBS CP traffic. Put another way, the BH link between the DU of BS 610 and network node 620 may include a BH RLC channel associated with QoS information of a CP traffic type for DL MBS CP traffic.

In some embodiments, a new priority may be introduced in the CP traffic type to support DL MBS CP traffic. For example, a CP traffic type may be defined specific for the DL MBS CP traffic. In some embodiments, separate new priorities may be used for broadcast and multicast services. For example, a CP traffic type for DL MBS CP traffic may include at least one of the following: a CP traffic type specific for a broadcast service or a CP traffic type specific for a multicast service. For example, a CP traffic type specific for the DL broadcast CP traffic and a CP traffic type specific for the DL multicast CP traffic may be respectively defined.

In some embodiments, the BH mapping information may include a default configuration for the BH link associated with the MBS associated traffic. In some embodiments, the BH mapping information may include a default configuration specific for DL MBS traffic (e.g., for DL MBS CP traffic, DL MBS UP traffic, or both). In some embodiments, the BH mapping information may include at least one of: a default configuration specific for DL MBS CP traffic or a default configuration specific for DL MBS UP traffic.

In some embodiments, the default configuration can be separately configured for broadcast and multicast. For example, the default configuration may include at least one of the following: a default configuration specific for a broadcast service or a default configuration specific for a multicast service. For example, the default configuration for the BH link associated with the MBS associated traffic may include at least one of: a default configuration associated with the broadcast associated traffic or a default configuration associated with the multicast associated traffic. For example, the default configuration specific for DL MBS traffic may include at least one of: a default configuration specific for DL broadcast traffic or a default configuration specific for DL multicast traffic. For example, the default configuration specific for DL MBS CP traffic may include at least one of: a default configuration specific for DL broadcast CP traffic or a default configuration specific for DL multicast CP traffic. For example, the default configuration specific for DL MBS UP traffic may include at least one of: a default configuration specific for DL broadcast UP traffic or a default configuration specific for DL multicast UP traffic.

In some embodiments, the default configuration may include at least one of the following: a default BH RLC CH (e.g., for DL) or a default BAP routing ID (e.g., for DL).

In the above embodiments, the default configuration can be configured via an F1AP message.

In operation 615, the DU of BS 610 may transmit MBS associated traffic (e.g., DL MBS CP or UP traffic) to network node 620 based on the received BH mapping information via the BH link between the DU of BS 610 and network node 620. The DU of BS 610 may receive the MBS associated traffic from the CU of BS 610, the CU-CP of BS 610, or CU-UP of BS 610.

For example, the BAP layer of the DU of BS 610 may transmit, to network node 620, a DL packet of MBS CP traffic or MBS UP traffic based on the BH mapping information, in response to receiving the DL packet from, for example, an upper layer or CU of BS 610.

For example, based on the IP header information (e.g., DL destination TNL or IP address, DSCP, IPv6 flow label, or any combination thereof) in the DL packet, the BAP layer of the DU of BS 610 may add the BAP routing ID in the corresponding information for the BH link as configured by the BH mapping information, and map the DL packet to the egress BH RLC CH in the corresponding information for the BH link as configured by the BH mapping information.

For example, based on the default configuration, the BAP layer of the DU of BS 610 may add a default DL BAP routing ID to the BAP header of the DL packet, and map the DL packet to a default DL BH RLC CH.

It should be appreciated by persons skilled in the art that the sequence of the operations in exemplary procedure 600 may be changed and some of the operations in exemplary procedure 600 may be eliminated or modified, without departing from the spirit and scope of the disclosure.

FIG. 7 illustrates a flow chart of exemplary procedure 700 for wireless communications in accordance with some embodiments of the present disclosure.

Details described in all of the foregoing embodiments of the present disclosure are applicable for the embodiments shown in FIG. 7. Exemplary procedure 700 may be performed by a BS (e.g., an IAB donor), which may include a CU and a DU coupled to the CU.

Referring to FIG. 7, in operation 711, the BS may transmit, from the CU to a network node or the DU, BH mapping information of MBS associated traffic, wherein the network node connects to the CU via the DU. The network node may be an IAB node.

In operation 713, the BS may transmit MBS associated traffic to the network node or receive MBS associated traffic from the network node, via the DU and a BH link between the DU and the network node, based on the BH mapping information.

For example, similar to FIGS. 4 and 5, the BS may transmit the BH mapping information of MBS associated traffic to the network node, and the network node may transmit MBS associated traffic to the BS based on the BH mapping information. For example, similar to FIG. 6, the BS may transmit the BH mapping information of MBS associated traffic to the DU, and the DU may transmit MBS associated traffic to the network node based on the BH mapping information.

In some embodiments of the present disclosure, transmitting the BH mapping information may include at least one of the following: transmitting, to the network node, information for the BH link associated with a non-UP traffic type for an MBS service; transmitting, to the network node, a mapping relation between a MRB or an endpoint of an F1 transport bearer of the CU and information for the BH link; transmitting, to the DU, a mapping relation between IP header information of an IP packet and information for the BH link; or transmitting, to the network node or the DU, a default configuration for the BH link associated with the MBS associated traffic.

In some embodiments of the present disclosure, the BS may transmit, from a CU-CP to a CU-UP, a DSCP of an IP packet for DL MBS traffic, an IPv6 flow label of the IP packet for the DL MBS traffic, or both; and wherein the CU includes the CU-CP and the CU-UP.

In some embodiments of the present disclosure, the BH link between the DU and the network node may include a BH RLC channel associated with QoS information of a control plane traffic type for DL MBS CP traffic.

In some embodiments of the present disclosure, the non-UP traffic type for an MBS service may include at least one of the following: a non-UP traffic type specific for a broadcast service or a non-UP traffic type specific for a multicast service. In some embodiments of the present disclosure, the non-UP traffic type for an MBS service may be at least one of the following: UE-associated F1AP, non-UE-associated F1AP, or non-F1.

In some embodiments of the present disclosure, the endpoint of the F1 transport bearer of the CU is indicated by at least one of the following: a broadcast bearer context F1-U TNL info at CU IE; or a MRB F1-U TNL info at CU IE for a multicast service.

In some embodiments of the present disclosure, the DSCP or the IPv6 flow label are associated with a MRB or an endpoint of an F1 transport bearer of the network node. In some embodiments of the present disclosure, the DSCP or the IPv6 flow label is associated with the IP packet transmitted through a GTP-U tunnel between the CU-UP and the network node of a MRB.

In some embodiments of the present disclosure, the control plane traffic type for DL MBS CP traffic may include at least one of the following: a control plane traffic type specific for a broadcast service or a control plane traffic type specific for a multicast service.

In some embodiments of the present disclosure, the default configuration may include at least one of the following: a default configuration specific for UL MBS CP traffic, a default configuration specific for UL MBS UP traffic, a default configuration specific for DL MBS CP traffic, a default configuration specific for DL MBS UP traffic, a default configuration specific for UL MBS traffic, or a default configuration specific for DL MBS traffic.

In some embodiments of the present disclosure, the default configuration may include at least one of the following: a default configuration specific for a broadcast service or a default configuration specific for a multicast service.

In some embodiments of the present disclosure, the information for the BH link may include at least one of the following: a BAP routing ID associated with the BH link, a next hop BAP address associated with the BH link, or an egress BH RLC channel ID associated with the BH link.

In some embodiments of the present disclosure, the IP header information of the IP packet may include at least one of the following: a destination IAB TNL or IP address of the IP packet, a differentiated DSCP of the IP packet, or IPv6 flow label of the IP packet.

In some embodiments of the present disclosure, the endpoint of the F1 transport bearer of the CU may include at least one of: a TNL address, a transport layer address or an IP address at the CU, or an endpoint identifier at the CU of a GTP tunnel between the CU and the network node.

In some embodiments of the present disclosure, the endpoint of the F1 transport bearer of the network node may include at least one of: a TNL address, a transport layer address or an IP address at the network node, or an endpoint identifier at the network node of a GTP tunnel between the CU and the network node.

It should be appreciated by persons skilled in the art that the sequence of the operations in exemplary procedure 700 may be changed and some of the operations in exemplary procedure 700 may be eliminated or modified, without departing from the spirit and scope of the disclosure.

FIG. 8 illustrates a flow chart of exemplary procedure 800 for wireless communications in accordance with some embodiments of the present disclosure. Details described in all of the foregoing embodiments of the present disclosure are applicable for the embodiments shown in FIG. 8. Exemplary procedure 800 may be performed by a network node (e.g., an IAB node).

Referring to FIG. 8, in operation 811, the network node may receive, from a BS, BH mapping information of MBS associated traffic. In operation 813, the network node may transmit MBS associated traffic to the BS via a BH link between the BS and the network node, based on the BH mapping information.

In some embodiments of the present disclosure, the BH mapping information may include at least one of the following: information for the BH link associated with a non-UP traffic type for an MBS service; a mapping relation between a MRB or an endpoint of an F1 transport bearer of a CU of the BS and information for the BH link; or a default configuration for the BH link associated with the MBS associated traffic.

In some embodiments of the present disclosure, the non-UP traffic type for an MBS service may include at least one of the following: a non-UP traffic type specific for a broadcast service or a non-UP traffic type specific for a multicast service. In some embodiments of the present disclosure, the non-UP traffic type for an MBS service may be at least one of the following: UE-associated F1AP, non-UE-associated F1AP, or non-F1.

In some embodiments of the present disclosure, the endpoint of the F1 transport bearer of the CU is indicated by at least one of the following: a broadcast bearer context F1-U TNL info at CU IE; or a MRB F1-U TNL info at CU IE for a multicast service.

In some embodiments of the present disclosure, the default configuration may include at least one of the following: a default configuration specific for UL MBS CP traffic, a default configuration specific for UL MBS UP traffic, or a default configuration specific for UL MBS traffic.

In some embodiments of the present disclosure, the default configuration may include at least one of the following: a default configuration specific for a broadcast service or a default configuration specific for a multicast service.

In some embodiments of the present disclosure, the information for the BH link may include at least one of the following: a BAP routing ID associated with the BH link, a next hop BAP address associated with the BH link, or an egress BH RLC channel ID associated with the BH link.

In some embodiments of the present disclosure, the endpoint of the F1 transport bearer of the CU may include at least one of: a TNL address or a transport layer address or an IP address at the CU, or an endpoint identifier at the CU of a GTP tunnel between the CU and the network node.

It should be appreciated by persons skilled in the art that the sequence of the operations in exemplary procedure 800 may be changed and some of the operations in exemplary procedure 800 may be eliminated or modified, without departing from the spirit and scope of the disclosure.

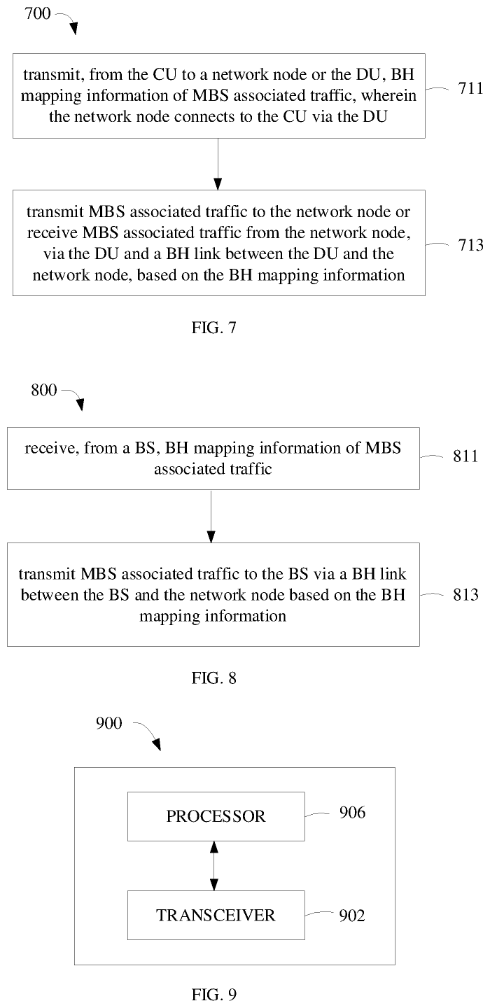

FIG. 9 illustrates a block diagram of exemplary apparatus 900 according to some embodiments of the present disclosure.

As shown in FIG. 9, the apparatus 900 may include at least one processor 906 and at least one transceiver 902 coupled to the processor 906. The apparatus 900 may be a network node (e.g., an IAB node) or a BS (e.g., an IAB donor, IAB donor-CU, or IAB donor-DU). In the case that apparatus 900 is a BS, apparatus 900 may further include a CU and a DU coupled to the CU. The CU and DU may be co-located or located separately. The CU and DU may be coupled to the processor 906.

Although in this figure elements such as the at least one transceiver 902 and processor 906 are described in the singular, the plural is contemplated unless a limitation to the singular is explicitly stated. In some embodiments of the present application, the transceiver 902 may be divided into two devices, such as a receiving circuitry and a transmitting circuitry. In some embodiments of the present application, the apparatus 900 may further include an input device, a memory, and/or other components.

In some embodiments of the present application, the apparatus 900 may be a BS. The processor 906 may interact with other element(s) (e.g., transceiver 902, a DU, or a CU) of the apparatus 900 so as to perform the operations with respect to the BSs, the IAB donors, IAB donor-CUs, or IAB donor-DUs described in FIGS. 1-8. In some embodiments of the present application, the apparatus 900 may be a network node. The transceiver 902 and the processor 906 may interact with each other so as to perform the operations with respect to the network nodes or the IAB nodes (mobile or stationary) described in FIGS. 1-8.

In some embodiments of the present application, the apparatus 900 may further include at least one non-transitory computer-readable medium.

In some embodiments of the present disclosure, the non-transitory computer-readable medium may have stored thereon computer-executable instructions to cause the processor 906 to implement the method with respect to the BSs, the IAB donors, IAB donor-CUs, or IAB donor-DUs as described above. For example, the computer-executable instructions, when executed, cause the processor 906 interacting with, for example, transceiver 902 to perform the operations with respect to the BSs, the IAB donors, IAB donor-CUs, or IAB donor-DUs described in FIGS. 1-8.

For example, in some embodiments of the present disclosure, the non-transitory computer-readable medium may have stored thereon computer-executable instructions to cause the processor 906 to implement the method with respect to the network node or the IAB nodes (mobile or stationary) as described above. For example, the computer-executable instructions, when executed, cause the processor 906 interacting with transceiver 902 to perform the operations with respect to the network nodes or the IAB nodes (mobile or stationary) described in FIGS. 1-8.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “handover,” “path switch,” and “migration” may be used interchangeably. The terms “includes,” “including,” or any other variations thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A base station (BS), comprising:
at least one memory; and
at least one processor coupled with the at least one memory and configured to cause the base station to:
transmit, from a centralized unit (CU) of the base station to a network node or a distributed unit (DU) of the base station coupled to the CU, backhaul (BH) mapping information of multicast/broadcast services (MBS) associated traffic, wherein the network node connects to the CU via the DU; and
transmit MBS associated traffic to the network node or receive MBS associated traffic from the network node, via the DU and a BH link between the DU and the network node, based on the BH mapping information.

2. The base station of claim 1, wherein transmitting the BH mapping information comprises at least one of the following:
transmitting, to the network node, information for the BH link associated with a non-user plane (UP) traffic type for a MBS service;
transmitting, to the network node, a mapping relation between a MBS radio bearer (MRB) or an endpoint of a F1 transport bearer of the CU and information for the BH link;
transmitting, to the DU, a mapping relation between internet protocol (IP) header information of an IP packet and information for the BH link; or
transmitting, to the network node or the DU, a default configuration for the BH link associated with the MBS associated traffic.

3. The base station of claim 1, wherein the at least one processor is configured to cause the base station to transmit, from a CU-control plane (CP) to a CU-user plane (UP), a differentiated services code point (DSCP) of an internet protocol (IP) packet for downlink (DL) MBS traffic, an IPv6 flow label of the IP packet for the DL MBS traffic, or both; and wherein the CU comprises the CU-CP and the CU-UP.

4. The base station of claim 1, wherein the BH link between the DU and the network node includes a BH radio link control (RLC) channel associated with quality-of-service (QOS) information of a control plane traffic type for downlink (DL) MBS control plane (CP) traffic.

5. The base station of claim 2, wherein the non-UP traffic type for a MBS service comprises at least one of the following: a non-UP traffic type specific for a broadcast service or a non-UP traffic type specific for a multicast service; or
wherein the non-UP traffic type for a MBS service is at least one of the following: user equipment (UE)-associated F1 application protocol (F1AP), non-UE-associated F1AP, or non-F1.

6. The base station of claim 3, wherein the DSCP or the IPv6 flow label are associated with a MRB or an endpoint of a F1 transport bearer of the network node; or
wherein the DSCP or the IPv6 flow label is associated with the IP packet transmitted through a general packet radio service tunneling protocol user plane (GTP-U) tunnel between the CU-UP and the network node of a MRB.

7. The base station of claim 4, wherein the control plane traffic type for DL MBS CP traffic comprises at least one of the following: a control plane traffic type specific for a broadcast service or a control plane traffic type specific for a multicast service.

8. The base station of claim 2, wherein the IP header information of the IP packet comprises at least one of the following: a destination IAB transport network layer (TNL) address of the IP packet, a destination IP address of the IP packet, a differentiated services code point (DSCP) of the IP packet, or IPv6 flow label of the IP packet.

9. The base station of claim 2, wherein the endpoint of the F1 transport bearer of the CU comprises at least one of:
a transport network layer (TNL) address, a transport layer address, or an IP address at the CU, or
an endpoint identifier at the CU of a general packet radio service tunneling protocol (GTP) tunnel between the CU and the network node.

10. The base station of claim 6, wherein the endpoint of the F1 transport bearer of the network node comprises at least one of:
a transport network layer (TNL) address, a transport layer address, or an IP address at the network node, or
an endpoint identifier at the network node of a general packet radio service tunneling protocol (GTP) tunnel between the CU and the network node.

11. A network node, comprising:
at least one memory; and
at least one processor coupled with the at least one memory and configured to cause the network node to:
receive, from a base station, backhaul (BH) mapping information of multicast/broadcast services (MBS) associated traffic; and
transmit MBS associated traffic to the base station via a BH link between the base station and the network node, based on the BH mapping information.

12. The network node of claim claim 11, wherein the BH mapping information comprises at least one of the following:
information for the BH link associated with a non-user plane (UP) traffic type for a MBS service;
a mapping relation between a MBS radio bearer (MRB) or an endpoint of a F1 transport bearer of a centralized unit (CU) of the base station and information for the BH link; or
a default configuration for the BH link associated with the MBS associated traffic.

13. The network node of claim claim 12, wherein the non-UP traffic type for a MBS service comprises at least one of the following: a non-UP traffic type specific for a broadcast service or a non-UP traffic type specific for a multicast service; or
wherein the non-UP traffic type for a MBS service is at least one of the following: user equipment (UE)-associated F1 application protocol (F1AP), non-UE-associated F1AP, or non-F1.

14. The network node of claim claim 12, wherein the endpoint of the F1 transport bearer of the CU comprises at least one of:
a transport network layer (TNL) address, a transport layer address, or an IP address at the CU, or
an endpoint identifier at the CU of a general packet radio service tunneling protocol (GTP) tunnel between the CU and the network node.

15. A method performed by a base station, the method comprising:
transmit, from a centralized unit (CU) of the base stationto a network node or a distributed unit (DU) of the base station, backhaul (BH) mapping information of multicast/broadcast services (MBS) associated traffic, wherein the DU is coupled to the CU and the network node connects to the CU via the DU; and
transmit MBS associated traffic to the network node or receive MBS associated traffic from the network node, via the DU and a BH link between the DU and the network node, based on the BH mapping information.

16. The method of claim 15, wherein transmitting the BH mapping information comprises at least one of the following:
transmitting, to the network node, information for the BH link associated with a non-user plane (UP) traffic type for a MBS service;
transmitting, to the network node, a mapping relation between a MBS radio bearer (MRB) or an endpoint of a F1 transport bearer of the CU and information for the BH link;
transmitting, to the DU, a mapping relation between internet protocol (IP) header information of an IP packet and information for the BH link; or
transmitting, to the network node or the DU, a default configuration for the BH link associated with the MBS associated traffic.

17. A method performed by a network node, the method comprising:
receiving, from a base station, backhaul (BH) mapping information of multicast/broadcast services (MBS) associated traffic; and
transmitting MBS associated traffic to the base station via a BH link between the base station and the network node, based on the BH mapping information.

18. The method of claim 17, wherein the BH mapping information comprises at least one of the following:
information for the BH link associated with a non-user plane (UP) traffic type for a MBS service;
a mapping relation between a MBS radio bearer (MRB) or an endpoint of a F1 transport bearer of a centralized unit (CU) of the base station and information for the BH link; or
a default configuration for the BH link associated with the MBS associated traffic.

19. The method of claim 18, wherein the non-UP traffic type for a MBS service comprises at least one of the following: a non-UP traffic type specific for a broadcast service or a non-UP traffic type specific for a multicast service; or
wherein the non-UP traffic type for a MBS service is at least one of the following: user equipment (UE)-associated F1 application protocol (F1AP), non-UE-associated F1AP, or non-F1.

20. The method of claim 18, wherein the endpoint of the F1 transport bearer of the CU comprises at least one of:
a transport network layer (TNL) address, a transport layer address, or an IP address at the CU, or
an endpoint identifier at the CU of a general packet radio service tunneling protocol (GTP) tunnel between the CU and the network node.
